(19) United States
(12) Patent Application Publication
(10) Pub. No.: US 2007/0160018 A1
(43) Pub. Date: Jul. 12, 2007

(54) Content access management

(75) Inventor: Jukka Alve, Vantaa (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/329,988

(22) Filed: Jan. 10, 2006

(51) Int. Cl. H04Q 7/24

(52) U.S. Cl. 370/338; 370/401

(57) ABSTRACT

Access control management within an access group, where at least two member devices create the access group. To allow mobile device being part of a quorum test, the right to issue response information can be transferred from mobile devices to stationary devices, which act as proxy devices and issue the response information as surrogate for the mobile devises.

### BACKGROUND OF THE INVENTION

The present patent application relates in general to content access management and digital rights management (DRM).

In the art, several digital rights management (DRM) schemes and content management and copy protection (CMCP) schemes are known. For example, from Digital Video Broadcasting (DVB) Project, “Content Protection and Copy Management”, DVB document A 094, November 2005, a content protection and copy management (CPCM) scheme is known.

According to this document, content that is protected and managed in conformance with the CPCM scheme can be delivered to users, and user consumption of the content may be controlled. Content can generally be audio-visual data, multimedia data, images, graphics, sounds, animations, web pages, text, games, software, e.g. in source code and object code, scripts, or any other data, which is intended to be delivered to and consumed by a user. Content protection can be provided by CPCM instances, which can be any kind of user devices for playing back the content. The CPCM instances may have functionality for content handling, access management, and security control.

Content handling may provide for receiving and transmitting protected and unprotected content. Security control may provide for transferring and securely storing, and maintaining protected content, as well as transferring data via a secure authenticated channel between CPCM devices.

Access management may be provided by use of an authorized domain (AD) management, which implements access management functionality. An AD can be considered as an access group. An AD is an agglomeration of devices, which have access rights to access content based on group wide access rules. The devices within an AD can be considered compliant with a common content management scheme, e.g. CPCM. The devices can be grouped according to certain criteria, for example, to be members of a single household, a certain premises or any other social, temporal or spatial group. Other logical groupings of devices into ADs are possible.

Devices, which are grouped into the AD can be locally located devices, as well as devices located spatially apart from the other devices. Portable and/or handheld devices, which can be connected discontinuously to the other devices of the AD may also be considered as part of the AD. Such devices can be, for instance, car stereo devices, mobile phones, MP3-Players, video players, mobile gaming consoles, etc.

The functionality of the AD management allows evaluating certain criteria before allowing new member devices to join the AD. The criteria, which need to be met, may be a numeric limit on how many devices are allowed within one authorized domain. Until the numeric limit is exceeded, new member devices are allowed to enter the AD. Once the numeric number is exceeded, entry into the AD is denied for new devices.

It has been found that ADs, where a plurality of mobile, spatially dislocated devices are present, the numeric limit of the number of devices allowed to the authorized domain imposes a problem. Enabling too many devices to enter the access group may create unfavorable circumstances for misuse, i.e. devices, which are usually not considered as belonging to one household may join the same AD.

It is therefore an object of the present patent application to improve access management within access groups, in particular authorized domains.

### BRIEF SUMMARY OF THE INVENTION

The present patent application provides, according to one aspect, a content access management method comprising generating an access group of at least two member devices, where the member devices of the access group have access right for accessing protected content, incorporating at least one new device into the access group based on response information received from member devices of the access group in response to a request of the new device to enter the access group, transferring the right to issue the response information from at least one member device to a proxy device within the access group, and issuing the response information by the proxy device as surrogate for the at least one member device that transferred the right to issue the response information to the proxy device.

The access group may be a group of devices within an AD. An AD may impose and access group. Devices within an AD may communicate with each other using known communication means, such as local networks, wide area networks, wireless networks, wired networks, ad-hoc networks and the like.

A response information can be considered as a “vote in favor of letting a new device join the access group”. The response information can be a signal issued by a device for reception within other devices. A response information may be issued upon reception of a request to join an AD by each of the member devices independently and may be received by any one of the member devices as well as the new device requesting to join the AD.

Enabling the transfer of the right to issue the response information from a member device to another member device, which then acts as proxy device, enables users to join new devices into the AD more easily. Even if already a high number of devices, preferably mobile, and portable devices, have been entered into the AD, it is still possible to add new devices to the AD. Even if the mobile devices are turned off, or not connected to the access group through a network, it is possible to enter a new device into the access group.

It has been found that the incorporation of new devices into the AD can be controlled by letting members of the AD issue response information after having received a join request of a new device.

Providing the response information by a certain fraction of the number of member devices of an access group can be considered as a quorum test. The quorum test only incorporates a new device into the access group, if a certain number of member devices of the same AD issue response information. If enough devices provide response information, the new device is incorporated into the AD.

However, with a high number of mobile or portable devices, which are either seldom powered up or connected to the access group, for instance, if they are usually outside the house, or frequently on travel, i.e. car stereo, mobile phone, mobile gaming devices, etc., it might become difficult that enough member devices issue their respective response information upon reception of a join request from a new device.

In order to solve this problem, the present invention provides the possibility that member devices transfer their right to issue the response information to another member device, which then acts as a proxy device. The proxy device issues the response information upon a join request of a new device instead of the member device that has transferred the right to issue the response information to the proxy device. Thus, the response information of the proxy device is a surrogate for the actual response information from the member device. The proxy device may also be understood as a placeholder for the device that has transferred its right. The device that has transferred its right to issue the response information may be excluded or prevented to issue the response information any further.

A further aspect of the present patent application is a content access module comprising an access control unit for controlling membership to an access group which provides access right for accessing protected content and for entering the access group by issuing a request to enter the access group and by receiving response information from member devices of the access group, a security control unit for securely communicating protected content with group members, and a proxy unit for transferring the right to issue a response information to and from at least one other member device, and for sending the response information as surrogate for the at least one other device.

A further aspect of the present patent application is a mobile device with a content access module comprising an access control unit for controlling membership to an access group which has access right for accessing content by issuing a request to enter the access group and receiving response information from member devices of the access group, a security control unit for securely communicating content with group members, and a proxy unit for transferring the right to issue a response information to at least one other member device.

Another aspect of the patent application is a stationary device with a content access module comprising an access control unit for controlling membership to an access group which has access right for accessing content by issuing a request to enter the access group and receiving response information from member devices of the access group, a security control unit for securely communicating content with group members, and a proxy unit for receiving the right to issue a response information from at least one other member device, and for sending the response information as surrogate for the at least one other device.

Still another aspect of the patent application is a content access management system comprising at least one mobile device with a content access module comprising an access control unit for controlling membership to an access group which has access right for accessing content by issuing a request to enter the access group and receiving response information from member devices of the access group, a security control unit for securely communicating content with group members, a proxy unit for transferring the right to issue a response information to at least one other member device, and at least one stationary device with a content access module comprising an access control unit for controlling membership to an access group which has access right for accessing content by issuing a request to enter the access group and receiving response information from member devices of the access group, a security control unit for securely communicating content with group members, and a proxy unit for receiving the right to issue a response information from at least one other member device, and for sending the response information as surrogate for the at least one other device.

Yet another aspect of the patent application is a a computer program product, tangibly stored on a storage medium, the program comprising instructions that, when executed, cause a processor to control membership to an access group which has access right for accessing content by issuing a request to enter the access group and receiving response information from member devices of the access group, and transfer the right to issue the response information from at least one member device to a proxy device within the access group.

Eventually, another aspect of the patent application is a computer program product, tangibly stored on a storage medium, the program comprising instructions that, when executed, cause a processor to control membership to an access group which has access right for accessing content by issuing a request to enter the access group and receiving response information from member devices of the access group, and receive the right to issue a response information from at least one other member device, and send the response information as surrogate for the at least one other device.

These and other aspects of the application will be described in more detail with reference to the following Figures.

### BRIEF DESCRIPTION OF THE DRAWINGS

In the Figures:

FIG. 1 illustrates a possible arrangement of an authorized domain;

FIG. 2 illustrates a member device of an authorized domain;

FIG. 3 illustrates a flowchart of a method according to embodiments.

### DETAILED DESCRIPTION OF THE INVENTION

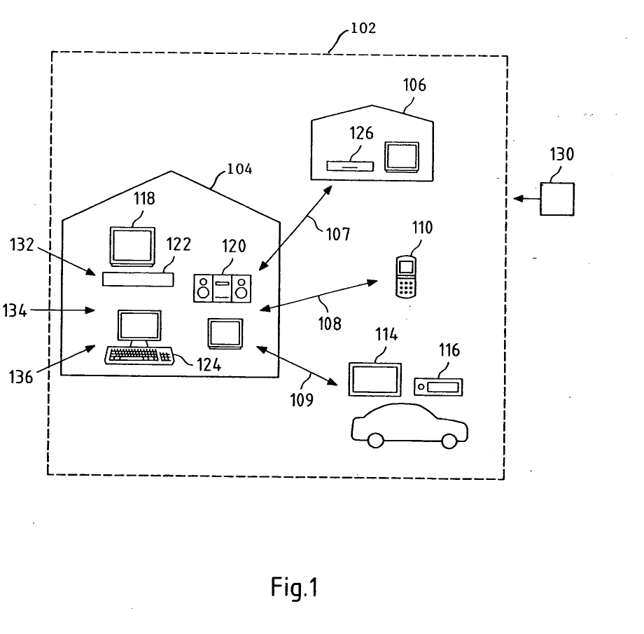

FIG. 1 illustrates an authorized domain (AD) 102, which may represent an access group. The AD 102 can be established by devices 118-124 connected via a local area network (LAN) in a house 104. Within house 104, different devices, such as a television set 118, a stereo set 120, a DVD player 122, and a computer 124 can be provided and interconnected using the LAN.

The AD 102 can comprise further devices located in outside premises 106, or being mobile devices. Within outside premises 106, various stationary display devices 126 can be provided and connected to the AD 102, for instance, via a broadband internet connection 107.

A mobile phone 110 can be connected to the AD 102 via a wireless communication network 108. Further mobile devices, such as a car stereo 116, a mobile multimedia player 114, and the like can be connected to the AD 102 via a wireless local area network (WLAN) 109.

The AD 102 can have identifiable, discrete bounds that allow distinguishing it from other authorized domains. The distinction of the AD 102 may be realized using membership management of member devices 110-126. Content being distributed within the AD 102 can be bound to the device 110-126, and only played back in these. By becoming members of the AD 102, devices gain access to content, which is bound to the AD 102, i.e. protected and with restricted access within the bounds of the AD 102.

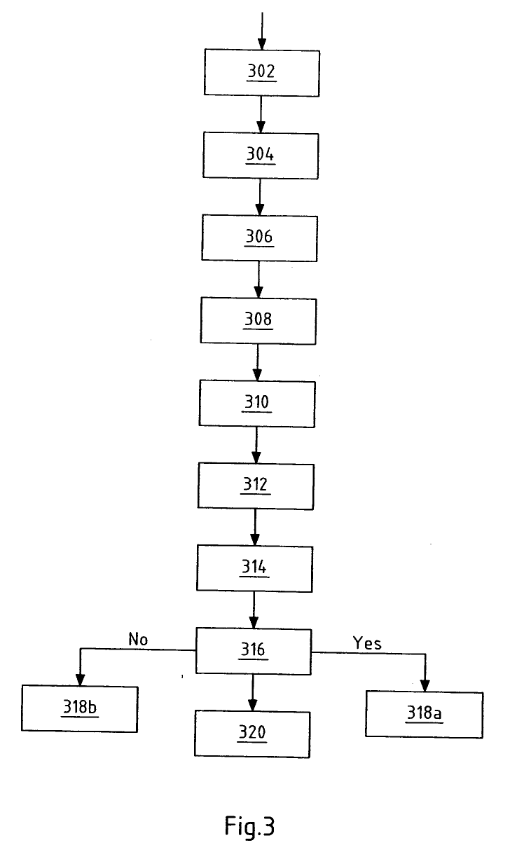

Already one single device 110-126 is able to establish a new AD 102. New devices 130 may enter the AD 102 by requesting to enter the AD 102. The method of entering the new device 130 into the AD 102 will be described in more detail with reference to FIG. 3.

Content can be delivered to AD 102 through various channels, for example through a radio broadcasting network 132, for example DVB-T, DVB-S, DVB-H, DVB-C, digital radio mondial (DRM), digital audio broadcast (DAB), and the like, a broadband network 134, for example a symmetric or asymmetric digital subscriber line (DSL) providing on-demand content using the Internet, as well as storage media, for example, compact discs 136, and the like. After having entered the AD 102 or prior to entering the AD 102, the content can be protected, such that it can only be played back by devices 110-126 being members of the AD 102.

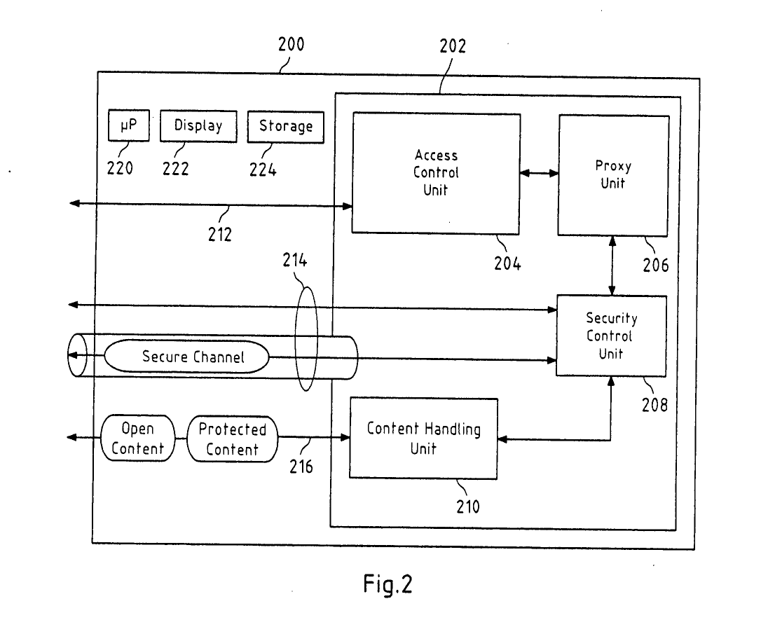

The process of entering an AD 102 by a device 130 does not require user interaction. The AD 102 can be considered as self-organizing structure, wherein the devices 110-126 organize themselves and have means, as illustrated in FIG. 2, to establish an AD 102 and to decide, whether a new device 130 can join the AD 102 or not. After joining an AD 102, new device 130 has access to content already existent and protected in the AD 102, according to access rules established in the AD 102.

The AD 102 can have a limited size, scope, or extent. This limitation can be the number of devices 110-126 being members of the AD 102. The limitation can be imposed by the devices 110-126 themselves. A fixed absolute number of member devices might be set for any AD 102. It is possible to terminate a device's membership in an AD 102, and after termination of the membership, access to the protected content is denied for that device.

FIG. 2 illustrates schematically a block diagram of a device 200 capable of being member of an AD 102.

Illustrated is a device 200, comprising a processor 220 for processing content and access control management operations, a display, or other playback means 222, and a storage 224 for storing content. Further comprised within device 200 is a module 202, being capable of access control management. Module 202 can comprise an access control unit 204, a proxy unit 206, a security control unit 208, and a content handling unit 210. Communication with other modules 202 and devices 200 is possible via an access control management interface 212, a secure communication interface 214, and a content interface 216.

Access control unit 204 communicates via access control management interface 212 with other access control units of other devices 200 in order to establish an AD 102, i.e. discovery of an AD 102, management of membership of an AD 102, as well as name management within an AD 102.

Security control unit 208 communicates with other security control units 208 of other devices 200 via secure communication interface 214. Via interface 214, secret communication between devices 200 is possible, i.e. for exchanging certificates and keys for content access.

Content handling unit 210 may receive open content as well as protected content via interface 216. Open content may be accessible by any device and is not protected, whereas protected content may be protected such that access control is imposed. Protection rules may define which storage, consumption, and export operations might be performed within a content's authorized usage. A common set of usage rules can be used, which are selectable by content providers to apply onto their content. The usage rules can be attached to the protected content as meta-data.

For enabling a new device 130 to enter an AD 102, even in case the AD 102 comprises a plurality of mobile devices, such as devices 110, 116, 118, a proxy unit 206 is provided within module 202. The proxy unit 206 can be arranged such that it can establish proxy functionality of the module 202 and/or transfer the right to issue response information to another device 200.

When the proxy unit 206 is arranged for proxy functionality, it can receive via access unit 204 from other devices 200 the information that the right to issue response information is transferred from the other module to the device 200. Upon reception of this transfer information, the proxy unit 206 acts within an AD 102 as surrogate for the device, which transferred its right to issue the response information. Upon reception of a join request from a new device 130, proxy unit 206 issues the response information instead of the device which transferred this right.

In addition and not only as alternative, proxy unit 206 can be arranged to transfer the right to issue response information to another device 200, for instance, if device 200 happens to be a mobile device. Proxy unit 206 can instruct access control unit 204 to transmit this right via interface 212 to another device 200. It may also be possible that this right is transferred securely via secure interface 214 using security control unit 208. Security may be available using data encryption.

The module 202 can be implemented in hardware (HW) and/or software (SW). As far as implemented in software, a software code stored on a computer readable medium realizes the described functions when being executed in processor 220 of the device 200.

Various devices 200 may form together an embodiment of a system according to the invention.

FIG. 3 illustrates a flowchart of a method for granting access to a new device 130 to an AD 102.

As illustrated in FIG. 3, within a first step 302, an AD 102 is generated. For example, two devices 118, 120 can communicate via their access control units 204 to establish an AD 102. Between the devices 118, 120, it can be agreed on their membership to the AD 102.

In a next step 304, the members of the AD 102 can exchange decryption keys for content decryption and domain secrets via interface 214.

In a further step 306, content may be received in a content handling unit 210 from networks 132, 134, of via a medium 136, using interface 214. Content can be shared between the member devices 118, 120 of the AD 102.

Protected content can be used by applying usage rules attached to the content. The usage of protected content can be made available using the decryption keys, which may have been exchanged through the security control unit 208 between member devices 118, 120.

During operation (308) of the AD 102, further devices may enter the AD 102. Eventually, devices 110-126 may all be members of the AD 102. New devices 130 can be added, until a numeric maximum number of member devices is reached.

It may happen that pluralities of member devices are mobile devices, which are seldom connected to the AD 102.

When a new device 130 wants to enter the AD 102, it may send a join request into the AD 102. Upon reception of such a join request, a quorum test may require a certain fraction of the devices 110-126 to respond to the new device's 130 join request. A certain number of devices have to answer in favor of letting the new device 130 to join the AD 102, i.e. a threshold number of member devices have to issue response information. The problem with such a quorum test is that in case a high number of mobile and portable devices are part of the AD 102, not enough response information in favor of letting the new device 130 to enter the AD 102 may be received.

Therefore, in a step 310, the mobile devices 110, 114, 116 may instruct their proxy units 206 to transfer their right to issue a response information to a stationary device, for example, to device 124. In this case, proxy units 206 of mobile device 110, 114, 116 transfer the right to issue response information from their access control units 204 to the proxy unit 206 of stationary device 124.

Within a step 312, using a secure communication via interface 214, the right is transferred via the networks 108, 109 to device 124. Device 124 receives this right within its proxy unit 206 upon which it may act as surrogate for the devices 110, 114, 116.

In case the right to issue response information has been transferred to device 124, device 124 may issue in a step 314, upon reception of a join request from new device 130, not only its own response information, but also the response information of devices 110, 114, 116. In this case, proxy unit 206 of device 124 instructs access control unit 204 to issue four separate response information data units.

Access control unit 204 of new device 130 receives the response information from the member devices as well as from the proxy device 124. Access control unit 204 of new device 130 checks (316) if a certain required number of response information is received.

Upon reception of a certain number of response information within new device 130, new device 130 enters AD 102 (318a). This may happen without taking the maximum number of allowed members of the AD 102 into account.

If the number of response information is lower than a certain threshold value, new device 130 cannot join the AD 102 (318b).

When mobile device 110 returns back into the vicinity of the AD 102, or turns its power on, it can request device 124 to re-transmit the right to issue a response information. In this case, device 124 instructs its proxy unit 206 to transfer back the right to issue response information to access control unit 204 of device 110 (320).

The use of the proxy unit 206 has the advantage that it will be much easier for new devices 130 to enter the AD 102, in case a high number of mobile or portable devices 110, 114, 116 are part of the AD 102. The mobile devices 110, 114, 116 need not to be connected to the network to allow a new device 130 to join the AD 102.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. It should also be recognized that any reference signs shall not be constructed as limiting the scope of the claims.

1. A content access management method comprising:
generating an access group of at least two member devices, where the member devices of the access group have access right for accessing protected content,
incorporating at least one new device into the access group based on response information received from member devices of the access group in response to a request of the new device to enter the access group,
transferring a right to issue the response information from at least one member device to a proxy device within the access group, and
issuing the response information by the proxy device as surrogate for the at least one member device that transferred the right to issue the response information to the proxy device.

2. The method of claim 1, wherein generating the access group comprises grouping the at least two member devices into a authorized domain, within which access to protected content is granted to member devices based on access rules.

3. The method of claim 1, wherein the proxy device is exactly one member device within the access group.

4. The method of claim 1, wherein the proxy device is a stationary member device within the access group.

5. The method of claim 1, further comprising transferring the right to issue the response information back from the proxy device to the at least one member device that transferred the right.

6. The method of claim 1, further comprising encrypting the transfer of the right to issue the response information between the proxy device and the member device.

7. The method of claim 1, wherein the member device which transfers the right to issue the response information to the proxy device is connected to the access group discontinuously.

8. The method of claim 7, wherein the member device which transfers the right to issue the response information to the proxy device is a mobile device.

9. The method of claim 1, further comprising limiting a duration within which a member device is designated as a proxy device.

10. The method of claim 1, wherein incorporating the new device into the access group requires a first threshold number of member devices to issue the response information.

11. The method of claim 10, wherein the first threshold number is defined as a fraction of a number comprising all member devices within the group.

12. The method of claim 1, further comprising defining a second threshold number determining a maximum number of member devices within the access group.

13. The method of claim 12, further comprising incorporating the new device into the access group when the number of member devices issuing the response information exceeds the first threshold, disregarding the second threshold value.

14. The method of claim 1, wherein the protected content is digital video, or audio content, or both.

15. A content access module comprising:
an access control unit for controlling membership to an access group which provides access right for accessing protected content and for entering the access group by issuing a request to enter the access group and by receiving response information from member devices of the access group,
a security control unit for securely communicating protected content with group members, and
a proxy unit for transferring a right to issue a response information to and from at least one other member device, and for sending the response information as surrogate for the at least one other device.

16. A mobile device with a content access module comprising:
an access control unit for controlling membership to an access group which has access right for accessing content by issuing a request to enter the access group and receiving response information from member devices of the access group,
a security control unit for securely communicating content with group members, and
a proxy unit for transferring a right to issue a response information to at least one other member device.

17. A stationary device with a content access module comprising:
an access control unit for controlling membership to an access group which has access right for accessing content by issuing a request to enter the access group and receiving response information from member devices of the access group,
a security control unit for securely communicating content with group members, and
a proxy unit for receiving a right to issue a response information from at least one other member device, and for sending the response information as surrogate for the at least one other device.

18. A content access management system comprising:
at least one mobile device with a content access module comprising:
an access control unit for controlling membership to an access group which has access right for accessing content by issuing a request to enter the access group and receiving response information from member devices of the access group,
a security control unit for securely communicating content with group members, and
a proxy unit for transferring a right to issue a response information to at least one other member device, and
at least one stationary device with a content access module comprising:
an access control unit for controlling membership to an access group which has access right for accessing content by issuing a request to enter the access group and receiving response information from member devices of the access group,
a security control unit for securely communicating content with group members, and
a proxy unit for receiving a right to issue a response information from at least one other member device, and for sending the response information as surrogate for the at least one other device.

19. A computer program product, tangibly stored on a storage medium, the program comprising instructions that, when executed, cause a processor to:
control membership to an access group which has access right for accessing content by issuing a request to enter the access group and receiving response information from member devices of the access group, and
transfer a right to issue the response information from at least one member device to a proxy device within the access group.

20. A computer program product, tangibly stored on a storage medium, the program comprising instructions that, when executed, cause a processor to:
control membership to an access group which has access right for accessing content by issuing a request to enter the access group and receiving response information from member devices of the access group, and
receive a right to issue a response information from at least one other member device, and send the response information as surrogate for the at least one other device.

21. A content access management device, comprising:
means for generating an access group of at least two member devices, where the member devices of the access group have access right for accessing protected content;
means for incorporating at least one new device into the access group based on response information received from member devices of the access group in response to a request of the new device to enter the access group;
means for tranferring a right to issue the response information from at least one member device to a proxy device within the access group; and
means for issuing the response information by the proxy device as surrogate for the at least one member device that transferred the right to issue the response information to the proxy device.

22. The device of claim 21, further comprising means for transferring the right to issue the response information back from the proxy device to the at least one member device that transferred the right.

23. The device of claim 21, further comprising means for encrypting the transfer of the right to issue the response information between the proxy device and the member device.

24. The device of claim 21, further comprising means for limiting a duration within which a member device is designated as a proxy device.

25. The device of claim 21, further comprising means for defining a second threshold number determining a maximum number of member devices within the access group.

26. The device of claim 25, further comprising means for incorporating the new device into the access group when the number of member devices issuing the response information exceeds the first threshold, disregarding the second threshold value.
